(19) United States
(12) Patent Application Publication
(10) Pub. No.: US 2026/0159784 A1
(43) Pub. Date: Jun. 11, 2026

(54) MULTIUSE COMPOSITIONS FOR MANUAL, PRESOAK, AND FLOORCARE APPLICATIONS

(71) Applicant: ECOLAB USA INC., Saint Paul, MN (US)

(72) Inventors: Wendy Lo, Woodbury, MN (US); Michael S. Rischmiller, Eagan, MN (US); Erik C. Olson, Eagan, MN (US); Kristopher Alan Hodgson, Burnsville, MN (US); Seth Louis Marquard, High Point, NC (US); Mandy Sunde, Mahtomedi, MN (US); Evan Y. Manderfield, Inver Grove Heights, MN (US)

(21) Appl. No.: 19/041,169

(22) Filed: Jan. 30, 2025

Related U.S. Application Data
(60) Provisional application No. 63/627,942, filed on Feb. 1, 2024.
(60) Provisional application No. 63/693,819, filed on Sep. 12, 2024.

(51) Int. Cl. C11D 17/00; C11D 1/74; C11D 3/10; C11D 3/37; C11D 3/386

(52) U.S. Cl. CPC C11D 17/0065; C11D 1/74; C11D 3/10; C11D 3/3761; C11D 3/38609; C11D 2111/14

(57) ABSTRACT

Solid multiuse and multipurpose compositions having enzyme and percarbonate to provide detergency and presoak capabilities with synergistic soils removal, including burnt food soil removal, are disclosed. The solid compositions are suitable for manual detergency, presoak applications and cleaning various hard surfaces, including floors. Methods of use are also described.

### CROSS-REFERENCE TO RELATED APPLICATIONS

This application claims priority under 35 U.S.C. § 119 to U.S. Provisional Application Ser. No. 63/693,819, filed on Sep. 12, 2024, and U.S. Provisional Application Ser. No. 63/627,942, filed on Feb. 1, 2024, which are herein incorporated by reference in its entirety.

### TECHNICAL FIELD

The disclosure relates generally to solid multiuse and multipurpose compositions having enzyme and percarbonate synergy to provide detergency and presoak capabilities for various soils including burnt food soils. This disclosure providing solid cleaning compositions further provides cleaning capabilities for hard surfaces including floors.

### BACKGROUND

The removal of burnt on and other soils such as polymerized soils is challenging. The longer these soils are left on surfaces, the more difficult it becomes to remove the soil from that surface. These challenging soils can be polymerized soils along with other burnt on food materials such as proteins, carbohydrates, and other fats. The result of any combination of these soils are hard to remove soils and residues. An example includes frying and baking operations. To effectively penetrate and remove these types of soils it is necessary to have a composition with both presoaking and detergency for a manual detergent application.

There remains increasing challenges in kitchens and other food preparation and processing facilities to remove such soils. Surfaces in need of removal of these challenging soils can be those in direct contact with the food processing. Additional surfaces can become soiled as well, including surrounding surfaces and floors.

It is an object of this disclosure to formulate both multipurpose and multiuse solid compositions comprising percarbonate and protease enzymes that are suitable for presoaking, manual detergent, and other hard surface cleaning.

It is another object of this disclosure to provide solid compositions comprising percarbonate and protease enzymes for efficient removal of burnt on and other challenging soils, including at a decreased concentration of chemistry resulting from synergy of the percarbonate and protease enzymes.

It is a still further object of the disclosure to provide the solid compositions that are suitable for use in removing soils from various surfaces, including ware, pots and pans, and other hard surfaces, including floors.

Other objects, embodiments and advantages of this disclosure will be apparent to one skilled in the art in view of the following disclosure, the drawings, and the appended claims.

### SUMMARY

It is a primary object, feature, and/or advantage of the present disclosure to provide multipurpose and multiuse solid compositions comprising percarbonate and protease enzymes that are suitable for presoaking, manual detergent, and other hard surface cleaning.

According to some aspects of the present disclosure, solid multiuse compositions comprise: from about 1 wt-% to about 50 wt-% of alkalinity sources comprising an alkali metal percarbonate and an alkali metal carbonate; a protease enzyme; from about 20 wt-% to about 80 wt-% of at least one solid sulfonate surfactant; and at least additional functional ingredient.

According to some additional aspects of the present disclosure, methods of cleaning a surface or article comprise contacting a surface or an article with a cleaning composition as described in any of the descriptions herein or claims in a dissolved aqueous solution.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a performance comparison of percentage of soil removal of Pot and Pan Control, Presoak Control 1, Presoak Control 2, Presoak Control 3, Multipurpose Composition 11, and Multipurpose Composition 12 when tested on stainless steel surfaces with burnt spaghetti soils.

FIG. 2 shows a performance comparison of percentage of soil removal of the various cleaning products evaluated in FIG. 1 when tested for abrasion against lasagna bolognese soils on melamine tiles.

FIG. 3A shows foam height for 300 ppm of both Pot and Pan Control and Multipurpose Composition.

FIG. 3B shows foam height for 1000 ppm of both Pot and Pan Control and Multipurpose Composition.

FIG. 3C shows foam height for 800 ppm versus 1000 ppm of Pot and Pan Control and Multipurpose Composition, respectively.

FIG. 4A shows a performance comparison of percentage of soil removal of Pot and Pan Control, Presoak Control 1, Presoak Control 2, Presoak Control 4, Multipurpose Composition (500 and 1000 ppm), Floorcare A, and Floorcare B when tested against Modified Red Soil on floor surfaces.

FIG. 4B shows a performance comparison of percentage of soil removal of Pot and Pan Control, Presoak Control 1, Presoak Control 2, Presoak Control 4, Multipurpose Composition (500 and 1000 ppm), Floorcare A, and Floorcare B when tested against Modified Red Soil on floor surfaces.

FIG. 4C shows a performance comparison of percentage of soil removal of Pot and Pan Control, Presoak Control 1, Presoak Control 2, Presoak Control 4, Multipurpose Composition (1000 ppm), Floorcare A, and Floorcare B when tested against Modified Red Soil on quarry tile floor surfaces.

FIG. 4D shows a performance visual comparison corresponding to the FIG. 4C data showing percentage of soil removal of Pot and Pan Control, Presoak Control 1, Presoak Control 2, Presoak Control 4, Multipurpose Composition (1000 ppm), Floorcare A, and Floorcare B when tested against Modified Red Soil on quarry tile floor surfaces.

FIG. 5 shows the percarbonate stability of evaluated Multipurpose Composition tablets including expanded sodium percarbonate over varying temperatures over time. Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that a synergy between percarbonate and protease enzymes in a solid composition provide efficacy manual and presoak detergency that both foams like a manual detergent and removes soils through presoaking capabilities through the combination of the enzymes with percarbonate which are particularly useful for removing challenging burnt food soils.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3 log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

An “antiredeposition agent” refers to a compound that helps keep suspended in water instead of redepositing onto the object being cleaned. Antiredeposition agents are useful in the present disclosure to assist in reducing redepositing of the removed soil onto the surface being cleaned.

As used herein, the term “between” is inclusive of any endpoints noted relative to a described range.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “configured” describes structure capable of performing a task or adopting a particular configuration. The term “configured” can be used interchangeably with other similar phrases, such as constructed, arranged, adapted, manufactured, and the like. Terms characterizing sequential order, a position, and/or an orientation are not limiting.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing, and non-to-low-aqueous food preparation lubricants, oils, and rinse additives.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “hard surface” refers to a solid, substantially non-flexible surface such as a counter top, tile, floor, wall, panel, window, plumbing fixture (e.g. drain), kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, food processing surfaces.

As used herein the term “molecular weight” refers to the mass of a molecule based on the chemical formula. The term “molecular weight” in referring to a polymer refers to the weight average molecular weight (Mw) that is calculated by taking the weight average of the molecular weights of individual monomers in a polymer. The specific method used to determine molecular weight will depend on the nature of the molecule and the available techniques. Examples of common methods to determine molecular weight include mass spectrometry, size exclusion chromatography (SEC), light scattering, osmometry, chemical analysis and viscometry.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, burnt on soils, polymerized soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “soil removal” or more specifically “percent (%) soil removal” can be calculated as follows:

$$100 - [ \frac{Residual soil wt ( g )}{Soil wt ( g ) \times 100} ] = \% Soil Removal$$

The term “substantially” refers to a great or significant extent. “Substantially” can thus refer to a plurality, majority, and/or a supermajority of said quantifiable variable, given proper context.

The term “surfactant” or “surface active agent” refers to an organic chemical that when added to a liquid changes the properties of that liquid at a surface.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

As used herein, the term “ware” refers to items such as eating and cooking utensils, dishes, pots and pans, etc. Ware can refer to various substrates, including for example, glass, porcelain, stone, metals, plastic, etc. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Compositions

According to embodiments, the multiuse compositions provide both manual detergent and presoak compositions. Without limiting any intended uses, the multiuse compositions are also used for various hard surface treatments and can be provided as hard surface cleaning compositions. This disclosure provides pressed solid cleaning compositions due to the inclusion of the enzyme and selected alkalinity sources, namely percarbonate alkalinity which are not compatible with cast and/or extrude solid processing. In embodiments the solid multiuse compositions include alkalinity source including at least an alkali metal percarbonate and alkali metal carbonates, protease enzyme, solid surfactants (including at least one sulfonate surfactant), and at least one optional additional functional ingredient.

Exemplary multiuse compositions are shown in Table 1 in weight percentages. While the components may have a percent actives of 100%, it is noted that Tables 1A-1B do not recite the percent actives of the components, but rather, recites the total weight percentage of the raw materials (i.e. active concentration plus inert ingredients, such as water).

TABLE 1A

| | First | Second | Third |
|---|---|---|---|
| | Exemplary | Exemplary | Exemplary |
| Material | Range wt.-% | Range wt.-% | Range wt.-% |
| Alkalinity Sources | 1-50 | 10-50 | 10-40 |
| Protease enzyme | 0.1-5 | 0.1-3 | 0.1-2 |
| Solid Surfactant(s), | 20-80 | 30-80 | 40-70 |
| namely sulfonates | | | |
| Additional Functional | 10-50 | 10-40 | 10-30 |
| Ingredients | | | |

TABLE 1B

| | First | Second | Third |
|---|---|---|---|
| | Exemplary | Exemplary | Exemplary |
| Material | Range wt.-% | Range wt.-% | Range wt.-% |
| Percarbonate salts | 1-30 | 5-30 | 10-30 |
| Carbonate salts | 1-20 | 1-15 | 2-15 |
| Protease enzyme | 0.1-5 | 0.1-3 | 0.1-2 |
| Solid Surfactant(s), | 20-80 | 30-80 | 40-70 |
| namely sulfonates | | | |
| Additional Functional | 10-50 | 10-40 | 10-30 |
| Ingredients | | | |

### Alkalinity Sources

The solid multiuse compositions comprise one or more alkalinity sources. The source of alkalinity is preferably an alkali metal percarbonate and an alkali metal carbonate. As referred to herein carbonate salts can include alkali metal carbonates and bicarbonates. Exemplary alkali metal carbonates that can be used include, but are not limited to, sodium carbonate, potassium carbonate, bicarbonate, sesquicarbonate, and mixtures thereof. Exemplary alkali metal percarbonates that can be used include, but are not limited to, sodium percarbonate.

A percarbonate material known as a modified anhydrous percarbonate salt, or an expanded percarbonate salt can also be used as an alkalinity source and a carrier. Expanded percarbonate is an absorbent base that is useful for absorbing liquid ingredients. The absorption capacity and the ability to absorb larger weights of liquid depends on the carrier's mass, bulk density and porosity. The modified anhydrous percarbonate salt can have a bulk density of about 0-0.62 to 0.7 g/mL and a hydrogen peroxide content of about 0.1 wt-% to less than 24 wt-%. In some preferred embodiments, the modified anhydrous percarbonate salt is a dry solid powder. In some embodiments, a modified anhydrous percarbonate salt is a percarbonate salt with less than about 24 wt-% of hydrogen peroxide. Beneficially the modified anhydrous percarbonate salt can load liquids onto the compound and in embodiments can absorb liquid in an amount up to (or hold up to) about 80 wt-% thereof. Additional disclosure of modified anhydrous percarbonate salts is disclosed in U.S. Pat. No. 8,652,434 the contents of which are incorporated herein by reference in their entirety.

Additional sources of alkalinity that are compatible with the other components of the composition may be included, such as for example, alkali metal salts, phosphates, amines, and mixtures thereof.

In embodiments the alkalinity sources require an alkali metal percarbonate and/or an alkali metal carbonate. In preferred embodiments the alkalinity source includes alkali metal percarbonate and an alkali metal carbonate. In still further embodiments the alkalinity source is an alkali metal percarbonate and an alkali metal carbonate and is free of other alkalinity and/or fillers such as silicates, phosphates, and the like.

In some embodiments, the alkalinity sources are included in the solid multiuse compositions at an amount of at least about 1 wt-% to about 50 wt-%, about 10 wt-% to about 50 wt-%, about 10 wt-% to about 40 wt-%, or about 10 wt-% to about 30 wt-%. In addition, without being limited according to the disclosure, all ranges recited are inclusive of the numbers defining the range and include each integer within the defined range.

In some embodiments, the alkalinity sources is an alkali metal percarbonate that is included in the solid multiuse compositions at an amount of at least about 1 wt-% to about 30 wt-%, about 5 wt-% to about 30 wt-%, about 10 wt-% to about 30 wt-%, or about 10 wt-% to about 20 wt-%. In addition, without being limited according to the disclosure, all ranges recited are inclusive of the numbers defining the range and include each integer within the defined range.

In some embodiments, the alkalinity source is an alkali metal carbonate that is included in the solid multiuse compositions at an amount of at least about 1 wt-% to about 20 wt-%, about 1 wt-% to about 15 wt-%, about 2 wt-% to about 15 wt-%, or about 5 wt-% to about 15 wt-%. In addition, without being limited according to the disclosure, all ranges recited are inclusive of the numbers defining the range and include each integer within the defined range.

### Enzymes

The solid multiuse compositions comprise a protease enzyme. Examples of commercially available proteases that may be incorporated in the detergent include those sold under the trade names Alcalase®, Savinase® (e.g., Savinase® Ultra 16L), Primase®, Durazym®, Esperase®, Coronase®, Blaze®, Liquanase®, Progress Uno®, Lavergy Pro®, Maxatase®, Maxacal®, Maxapem®, Opticlean®, Optimase® PR, Effectenz®, Purafect®, and Purafect OX. Mixtures of different protease enzymes may also be incorporated in the detergent. Further, while various specific enzymes have been described, it should be appreciated that any protease which can confer the desired proteolytic activity to the composition may be used and the disclosure is not limited to any specific protease. In a preferred embodiment, the enzyme is Savinase® or Progress Uno, which are available from Novozymes.

Commercial enzymes, such as alkaline proteases, are obtainable in liquid or dried form, are sold as raw aqueous solutions or in assorted purified, processed and compounded forms, and include about 2% to about 80% by weight active enzyme generally in combination with stabilizers, buffers, cofactors, impurities and inert vehicles. The actual active enzyme content depends upon the method of manufacture and is not critical; assuming the solid multiuse composition has the desired enzymatic activity. The particular enzyme chosen for use in the process and products of this invention depends upon the conditions of final utility, including the physical product form, use pH, use temperature, and soil types to be degraded or altered. The enzyme can be chosen to provide optimum activity and stability for any given set of utility conditions.

The cleaning compositions of the present invention can include at least a protease for cleaning protein-containing soils. Further, enhanced protease activity can occur in the presence of one or more additional enzymes, such as amylase, cellulase, lipase, peroxidase, endoglucanase enzymes and mixtures thereof, preferably cellulase, lipase or amylase enzymes.

Preferred selections are influenced by factors such as pH-activity and/or stability optima, thermostability, and stability to active detergents, builders and the like. In this respect bacterial enzymes are preferred, such as bacterial proteases. A valuable reference on enzymes is “Industrial Enzymes”, Scott, D., in Kirk-Othmer Encyclopedia of Chemical Technology, 3rd Edition, (editors Grayson, M. and EcKroth, D.) Vol. 9, pp. 173 224, John Wiley & Sons, New York, 1980. When using enzymes, the methods of cleaning may also include the use of an enzyme stabilizing agent.

The protease enzyme is a “detersive enzyme”, as used herein, which refers to an enzyme having a cleaning, destaining or otherwise beneficial effect as a component of a solid multiuse composition for various surfaces. Beneficially the protease enzyme is the multiuse compositions provides desirable activity for removal of protein-based, carbohydrate-based, and/or triglyceride-based stains from a surface, including in a manual detergent application, for cleaning, destaining, and sanitizing presoaks, such as presoaks for equipment, ware including flatware, cooking ware, and table ware, presoaks for pots and pans, presoaks for meat cutting equipment, etc. Although not limiting to the present disclosure, enzymes suitable for the solid multiuse compositions can act by degrading or altering one or more types of soil residues encountered on a ware or other hard surface thus removing the soil or making the soil more removable by a surfactant or other component of the composition. Both degradation and alteration of soil residues can improve detergency by reducing the physicochemical forces that bind the soil to the surface being cleaned, i.e., the soil becomes more water soluble. For example, one or more proteases can cleave complex, macromolecular protein structures present in soil residues into simpler short chain molecules which are, of themselves, more readily desorbed from surfaces, solubilized or otherwise more easily removed by detersive solutions containing said proteases.

In some embodiments only a protease enzyme is included in the solid compositions as the only enzyme. In other embodiments an additional suitable enzyme(s) may be combined with the protease. In some embodiments an additional enzyme is added with the protease enzyme, which can include an amylase, a lipase, a gluconase, a cellulase, a peroxidase, a pectinase, a mannanase, or a mixture thereof of any suitable origin, such as vegetable, animal, bacterial, fungal or yeast origin. In an embodiment a protease enzyme is combined with an amylase enzyme. In another embodiment a protease enzyme is combined with a lipase enzyme. In yet another embodiment a protease enzyme is combined with a cellulase enzyme.

In some embodiments, the protease enzyme is included in the solid multiuse compositions at an amount of about 0.01 wt-% to about 10 wt-%, about 0.1 wt-% to about 5 wt-%, about 0.1 wt-% to about 3 wt-%, or about 0.1 wt-% to about 2 wt-%. In additional embodiments, the protease enzyme is included in the solid multiuse compositions at an amount of at least about 0.5 wt-% to about 5 wt-%, about 0.5 wt-% to about 3 wt-%, or about 0.5 wt-% to about 2 wt-%. In addition, without being limited according to the disclosure, all ranges recited are inclusive of the numbers defining the range and include each integer within the defined range.

In some embodiments, where an additional enzyme (in addition to the protease enzyme) is included in the solid multiuse compositions, it is included at an amount of about 0.01 wt-% to about 10 wt-%, about 0.1 wt-% to about 5 wt-%, about 0.1 wt-% to about 3 wt-%, or about 0.1 wt-% to about 2 wt-%. In additional embodiments, the protease enzyme and the additional enzyme are included in the solid multiuse compositions at an amount of about 0.1 wt-% to about 10 wt-%, about 0.1 wt-% to about 5 wt-%, or about 0.5 wt-% to about 5 wt-%. In addition, without being limited according to the disclosure, all ranges recited are inclusive of the numbers defining the range and include each integer within the defined range.

### Solid Sulfonate Surfactants

The solid multiuse compositions comprise at least one solid surfactant or a surfactant that can be solidified. In embodiments the solid surfactant is a sulfonate surfactant. Solid sulfonate surfactants can be crystalline or non-crystalline. Exemplary sulfonates include alkylsulfonates, alkylbenzenesulfonates, alkylarylsulfonates, sulfonated fatty acid esters, and the like.

In a preferred embodiment, the solid sulfonate surfactant is a salt of LAS (such as sodium linear alkylbenzene sulfonate), salt of alpha olefin sulfonate (C14-16 sodium AOS), sodium xylene sulfonate, sodium cumene sulfonate, or combinations thereof.

In some embodiments, the solid sulfonate surfactant is included in the solid multiuse compositions at an amount of at least about 20 wt-% to about 80 wt-%, about 30 wt-% to about 80 wt-%, about 40 wt-% to about 70 wt-%, or about 50 wt-% to about 70 wt-%. In addition, without being limited according to the disclosure, all ranges recited are inclusive of the numbers defining the range and include each integer within the defined range.

### Additional Functional Ingredients

The components of the solid multiuse compositions can further be combined with various functional components suitable for uses disclosed herein, including manual detergents, presoak applications and other hard surface cleaning. In some embodiments, the multiuse compositions including the alkalinity source comprising an alkali metal percarbonate and alkali metal carbonate, protease enzyme, solid sulfonate surfactant, and at least one optional additional functional ingredient make up a large amount, or even substantially all of the total weight of the compositions. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include foaming or defoaming agents, bleaching agents, solubility modifiers, dispersants, metal protecting agents, soil antiredeposition agents, stabilizing agents, corrosion inhibitors, builders, sequestrants and/or chelating agents, sanitizers and/or antimicrobial agents, additional enzymes, such as those particularly suitable for other hard surface applications (e.g. cellulases for floorcare, drain cleaning and drain fly habitat reduction), aesthetic enhancing agents including fragrances and/or dyes, rheology and/or solubility modifiers, builders or fillers, processing aids, pH adjusting agents, complexing agents, soil release polymers, hydrotropes or couplers, buffers, solvents, additional surfactants and/or cleaning agents and the like.

Preferred additional functional ingredients that can be incorporated into the compositions include, but are not limited to, additional surfactants, namely nonionic surfactants selected from coco monoethanolamide and an alcohol ethoxylate, fillers, including sulfates, polymers, dyes and/or fragrances, and combinations thereof.

According to embodiments of the disclosure, the various additional functional ingredients may be provided in a composition in the amount from about 0 wt-% and about 30 wt-%, from about 0.1 wt-% and about 25 wt-%, from about 0.1 wt-% and about 20 wt-%, from about 0.5 wt-% and about 20 wt-%, or from about 1 wt-% and about 20 wt-%. In addition, without being limited according to the disclosure, all ranges recited are inclusive of the numbers defining the range and include each integer within the defined range.

### Additional Surfactants

Additional surfactants, including additional non-sulfonate surfactants can be included in the solid multiuse compositions for various performance and/or processing effects. In some embodiments additional surfactants can be liquid and/or solid surfactants.

In a preferred embodiment, at least one nonionic surfactant is included, for example alcohol ethoxylates, EO-PO block copolymers, amides (lauryl diethanolamide, cocamide DEA, cocoamide MEA, cocamide mono isopropanolamine PEG 6 lauramide, etc.) or combinations thereof.

Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties.

Useful nonionic surfactants include:
(1) Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-functional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.
(2) Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.
(3) Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.
(4) Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Disponil manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

Examples of nonionic low foaming surfactants include:
(5) Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.
(6) Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.
(7) The alkylphenoxypolyethoxyalkanols of U.S. Pat. No. 2,903,486 issued Sep. 8, 1959 to Brown et al. and represented by the formula

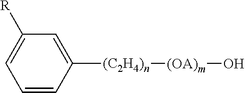

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)˜OH]z wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CONR₁Z in which: R1 is H, C₁-C₄ hydrocarbyl, 2-hydroxy ethyl, 2-hydroxy propyl, ethoxy, propoxy group, or a mixture thereof, R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use in the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions include alcohol alkoxylates, EO/PO block copolymers, alkylphenol alkoxylates, and the like.

### Semi-Polar Nonionic Surfactants

The semi-polar type of nonionic surface active agents are another class of nonionic surfactant useful in compositions. Generally, semi-polar nonionics are high foamers and foam stabilizers, which can limit their application in CIP systems. However, within compositional embodiments designed for high foam cleaning methodology, semi-polar nonionics have utility. The semi-polar nonionic surfactants include the amine oxides, phosphine oxides, sulfoxides and their alkoxylated derivatives.

Amine oxides are tertiary amine oxides corresponding to the general formula:

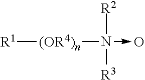

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof, R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

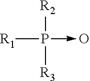

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

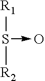

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Nonionic surfactants suitable for use with the compositions include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC 11; mixtures thereof, or the like.

Also useful in the compositions are surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. As those skilled in the art understand, anionics are excellent detersive surfactants and are therefore favored additions to heavy duty detergent compositions.

Anionic sulfate surfactants include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)
in which R is a C₈ to C₂₂ alkyl group or

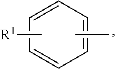

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1. In other embodiments, R is

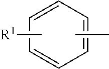

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

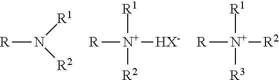

in which, R represents an alkyl chain, R′, R″, and R′″ may be either alkyl chains or aryl groups or hydrogen and X represents an anion. The amine salts and quaternary ammonium compounds are preferred for practical use in this invention due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

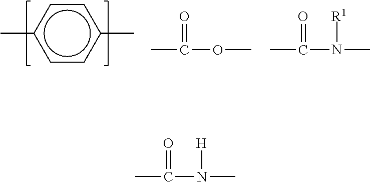

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is can be a group including, but not limited to:

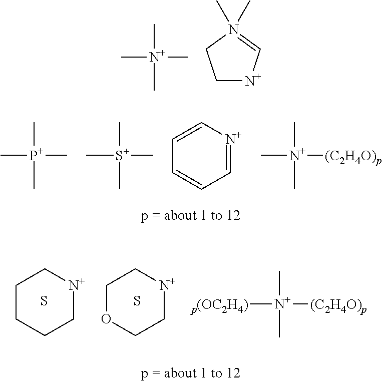

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives which can be used in the compositions generally have the general formula:

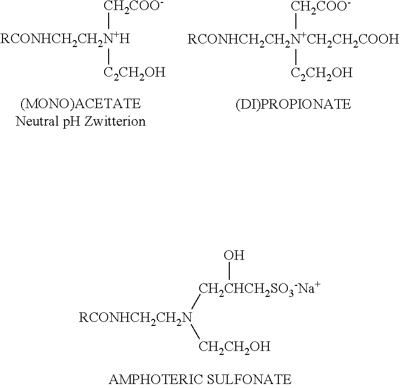

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ from Solvay Novecare, Princeton, N.J. Another suitable coconut derived amphoteric surfactant with the chemical name disodium cocoampho diacetate is sold under the tradename Mirataine™, also from Solvay Novecare, Princeton, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

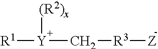

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

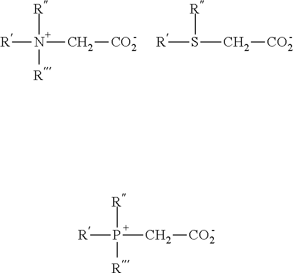

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines which may be useful in the compositions include those compounds having the formula (R(R¹)₂ N⁺ R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated in their entirety.

In some embodiments, the additional surfactant(s) is included in the solid multiuse compositions at an amount of at least about 0.1 wt-% to about 10 wt-%, about 0.5 wt-% to about 10 wt-%, about 1 wt-% to about 10 wt-%, or about 1 wt-% to about 6 wt-%. In addition, without being limited according to the disclosure, all ranges recited are inclusive of the numbers defining the range and include each integer within the defined range.

### Fillers

The solid multiuse compositions can optionally include one or more of a filler. Some examples of suitable fillers may include sodium chloride, starch, sugars, C₁-C₁₀ alkylene glycols such as propylene glycol, sulfates, such as sodium sulfate and/or magnesium sulfate, sodium acetate, PEG, urea, sodium acetate, and the like.

In preferred embodiments the filler is a water soluble salt, such as magnesium salt which can be selected from magnesium sulfate, magnesium chloride, magnesium sulfate heptahydrate, magnesium chloride hexahydrate, magnesium nitrate and magnesium acetate and the hydrates thereof. In further preferred embodiments the filler is a water soluble sodium salt, such as sodium sulfate.

In some embodiments, the filler is included in the solid multiuse compositions at an amount of at least about 0.1 wt-% to about 40 wt-%, from about 0.1 wt-% to about 20 wt-%, about 0.5 wt-% to about 20 wt-%, about 1 wt-% to about 20 wt-%, or about 5 wt-% to about 20 wt-%. In addition, without being limited according to the disclosure, all ranges recited are inclusive of the numbers defining the range and include each integer within the defined range.

### Polymers

The cleaning compositions can include a polymer or a polymer system comprised of at least one polycarboxylic acid polymer, homopolymer, copolymer, and/or terpolymer. Particularly suitable polycarboxylic acid polymers, include, but are not limited to, polymaleic acid homopolymers, polyacrylic acid copolymers, acrylic acid homopolymers, and maleic anhydride/olefin copolymers.

Polymaleic acid (C₄H₂O₃)x or hydrolyzed polymaleic anhydride or cis-2-butenedioic acid homopolymer, has the structural formula:

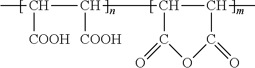

where n and m are any integer and wherein maleic acid moieties and maleic anhydride moieties may be arranged statistically or block-wise. Examples of polymaleic acid homopolymers, copolymers, and/or terpolymers (and salts thereof) which may be used for the invention are particularly preferred are those with a molecular weight of about 1000 and about 25,000, more preferably between about 1000 and about 5000. Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel.

The cleaning compositions can use acrylic acid homopolymers, polyacrylic acid polymers, copolymers, and/or terpolymers. Poly acrylic acids have the following structural formula:

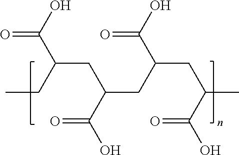

where n is any integer. Examples of suitable polyacrylic acid polymers, copolymers, and/or terpolymers, include but are not limited to, the polymers, copolymers, and/or terpolymers of polyacrylic acids, (C₃H₄O₂)ₙ or 2-Propenoic acid, acrylic acid, polyacrylic acid, propenoic acid. A particularly preferred homopolymer of acrylic acid, available from Rohm and Haas is ACUSOL® 445 with an average molecular weight of 4500.

In an embodiment, particularly suitable acrylic acid polymers, copolymers, and/or terpolymers have a molecular weight between about 100 and about 10,000, in a preferred embodiment between about 500 and about 7000, in an even more preferred embodiment between about 1000 and about 5000, and in a most preferred embodiment between about 1500 and about 3500. Examples of polyacrylic acid polymers, copolymers, and/or terpolymers (or salts thereof) which may be used for the invention include, but are not limited to, Acusol 448 and Acusol 425 from The Dow Chemical Company, Wilmington Delaware, USA. In particular embodiments it may be desirable to have acrylic acid polymers (and salts thereof) with molecular weights greater than about 10,000. Examples, include but are not limited to, Acusol 929 (10,000 MW) and Acumer 1510 (60,000 MW) both also available from Dow Chemical, AQUATREAT AR-6 (100,000 MW) from AkzoNobel Strawinskylaan 2555 1077 ZZ Amsterdam Postbus 75730 1070 AS Amsterdam.

Maleic anhydride/olefin copolymers are copolymers of polymaleic anhydrides and olefins. Maleic anhydride (C₂H₂(CO)₂O has the following structure:

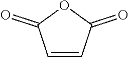

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl (C₁₋₁₈) esters of the foregoing acids, cycloalkyl(C₃₋₈) esters of the foregoing acids, sulfated castor oil, or the like.

At least 95 wt % of the maleic anhydride polymers, copolymers, or terpolymers have a number average molecular weight of in the range between about 700 and about 20,000, preferably between about 1000 and about 100,000.

A variety of linear and branched chain alpha-olefins can be used for the purposes of this invention. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄₋₁₀, such as isobutylene, 1-butene, 1-hexene, 1-octene, and the like.

In an embodiment, particularly suitable maleic anhydride/olefin copolymers have a molecular weight between about 1000 and about 50,000, in a preferred embodiment between about 5000 and about 20,000, and in a most preferred embodiment between about 7500 and about 12,500. Examples of maleic anhydride/olefin copolymers which may be used for the invention include, but are not limited to, Acusol 460N from The Dow Chemical Company, Wilmington Delaware, USA.

In some embodiments, the polymers are included in the solid multiuse compositions at an amount of at least about 0.1 wt-% to about 15 wt-%, about 0.5 wt-% to about 10 wt-%, or about 0.5 wt-% to about 5 wt-%, wherein all wt-% are based on an actives basis of the polymer. In addition, without being limited according to the disclosure, all ranges recited are inclusive of the numbers defining the range and include each integer within the defined range.

### Chelants

Suitable chelants include aminocarboxylates and polycarboxylates. Some examples of aminocarboxylates useful as chelating/sequestering agents, include, N-hydroxyethyliminodiacetic acid, nitrilotriacetic acid (NTA), ethylenediaminetetraacetic acid (EDTA), N-hydroxyethyl-ethylenediaminetriacetic acid (HEDTA) (in addition to the HEDTA used in the binder), diethylenetriaminepentaacetic acid (DTPA), methylglycine diacetic acid (MGDA), glutamic acid diacetic acid (GLDA), or salts thereof, and the like. Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In embodiments of the solid cleaning composition which are not phosphate-free, added chelating/sequestering agents may include, for example a condensed phosphate, a phosphonate, and the like. Some examples of condensed phosphates include sodium and potassium orthophosphate, sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

In embodiments of the solid cleaning composition which are not phosphate-free, the composition may include a phosphonate such as 1-hydroxyethane-1,1-diphosphonic acid CH₃C(OH)[PO(OH)₂]₂; aminotri(methylenephosphonic acid) N[CH₂ PO(OH)₂]₃; aminotri(methylenephosphonate), sodium salt

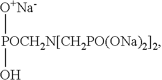

2-hydroxyethyliminobis(methylenephosphonic acid) HOCH₂ CH₂ N[CH₂ PO(OH)₂]₂; diethylenetriaminepenta(methylenephosphonic acid) (HO)₂ POCH₂ N[CH₂ N[CH₂ PO(OH)₂]₂]2; diethylenetriaminepenta(methylenephosphonate), sodium salt C₉ H₍₂₈₋ₓ₎ N₃ NaₓO₁₅P₅(x=7); hexamethylenediamine(tetramethylenephosphonate), potassium salt C₁₀ H₍₂₈₋ₓ₎N₂KₓO₁₂P₄ (x=6); bis(hexamethylene)triamine(pentamethylenephosphonic acid) (HO₂)POCH₂N[(CH₂)₆ N[CH₂ PO(OH)₂]₂]₂; and phosphorus acid H₃PO₃. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

In some embodiments, the chelant (or builder or sequestrant) is included in the solid multiuse compositions at an amount of at least about 0.1 wt-% to about 10 wt-%, about 0.5 wt-% to about 10 wt-%, or about 1 wt-% to about 10 wt-%. In addition, without being limited according to the disclosure, all ranges recited are inclusive of the numbers defining the range and include each integer within the defined range.

### Methods of Making Solids

The solid compositions are substantially homogeneous with regard to the distribution of ingredients throughout its mass and are dimensionally stable.

The solid multiuse compositions are preferably pressed solids. In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid cleaning composition. Pressure may be applied by a block machine or a turntable press, or the like. Pressure may be applied at about 1 to about 3000 psi, about 5 to about 2500 psi, or about 10 psi to about 2000 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid cleaning composition. As referred to herein, an uncured composition including the flowable solid is compressed to provide sufficient surface contact between particles making up the flowable solid that the uncured composition will solidify into a stable solid cleaning composition. A sufficient quantity of particles (e.g. granules) in contact with one another provides binding of particles to one another effective for making a stable solid composition. Inclusion of an optional curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provides numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid cleaning compositions. Moreover, pressed solid compositions retain its shape under conditions in which the composition may be stored or handled.

By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose or a multidose solid, or another solid form known to those of skill in the art. The degree of hardness of the pressed solid composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and particularly up to approximately 120° F.

The resulting solid composition may take forms including, but not limited to: pressed solid product; including a molded or formed pressed solid pellet, block, tablet, powder, granule, flake; or the formed solid can thereafter be ground or formed into a powder, granule, or flake. In an exemplary embodiment, a solid block composition formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

### Methods of Use

The solid multiuse compositions having enzyme and percarbonate synergy provide efficacious detergency and presoak capabilities for various soils including burnt food soils. The solid multiuse compositions are also effective for soil removal of various additional hard surfaces. Beneficially, the solid multiuse compositions can even be dissolved to form aqueous solutions that are concentrates or use solutions that are suitable for use in presoaking, soil removal, and cleaning of more than one surface or article either at either the same or a different dilution level. This provides various formulation benefits and benefits to a consumer able to use a single solid multiuse composition for various applications of use, e.g. soaking ware and cleaning hard surfaces, such as floorcare.

The solid multiuse compositions can be used by contacting a surface or an article with the compositions in dissolved form, i.e. a dissolved aqueous solution. The methods of use can encompass various manners of dispensing the solid multiuse compositions. Thereafter the dissolved aqueous solution are contained in a spray bottle to be sprayed onto a surface, a bucket or other housing to be wiped onto a surface, e.g. using a rag, mop, or other substrate.

Preferably, the compositions are dispensed in dissolved form. The compositions can be diluted as part of the dispensing, before dispensing, after dispensing, or a combination thereof. After dispensing, the composition can contact a surface (as referred to here as surface or an article). As described herein, surfaces can comprise a hard surface, ware and other articles. Preferably, the compositions are in dissolved and diluted form. In some embodiments, the solid multiuse compositions can contact a surface or article and subsequently be dissolved on the surface with the addition of water. In some embodiments, the solid multiuse compositions can contact a surface or article in dissolved form and then be diluted while in contact with the surface. The methods can further comprise rinsing the surface or article with water before and/or after contact with the cleaning composition.

Articles include ware, such as eating and cooking utensils, dishes, pots and pans, etc. which can be made of various substrates. Surfaces include various hard surfaces in need of soil removal, such as a countertop, tile, floor, wall, panel, window, plumbing fixture (e.g. drain), kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, food processing surfaces.

The dissolved aqueous solution of the solid multiuse composition can be applied to surfaces, including articles of ware, using a variety of methods. These methods can operate on an object, surface, or the like, by contacting the object or surface with the composition. Contacting can comprise any of numerous methods for applying the dissolved aqueous solution of the solid multiuse composition, such as spraying, immersing or soaking, coating, wiping, or a combination thereof. Contacting in terms of use of the composition as a floorcare composition can be applied by mopping, brushing, wiping, spraying, pouring, or with a machine.

Without being limited to the contacting according to the disclosure, a concentrate or use liquid composition can be applied to or brought into contact with a surface or object by any conventional method or apparatus for applying a liquid composition to an object. For example, the surface can be wiped with, sprayed with, foamed on, and/or immersed in the liquid compositions. The dissolved aqueous solution of the solid multiuse composition can be sprayed, foamed, or wiped onto a surface; the compound can be caused to flow over the surface, or the surface can be dipped into the compound. Contacting can be manual or by machine.

In a preferred embodiment the dissolved aqueous solution of the solid multiuse composition is employed as a presoak for soil removal, including burnt on and other challenging soils. Presoaks are often employed for ware including pots and pans. It is beneficial that the compositions described herein provide foaming and soaking properties able to remove the burnt on challenging soils. In embodiments the soils are at least about 80% removed, at least about 90% removed, or preferably about 100% removed after the presoak for a desired time and at a desired temperature, based on a calculation of percent (%) soil removal. In embodiments little to no manual force is required to remove the soils, including those burnt on a surface in need of a presoak.

Additional embodiments include using the dissolved aqueous solution of the solid multiuse composition as a conventional manual detergent while maintaining the efficacy of challenging soil removal as due to the synergy of at least the percarbonate and protease enzymes in the composition. In embodiments the soils on water treated in a manual detergent application are about 100% removed, based on a calculation of percent (%) soil removal.

In other embodiments, using the dissolved aqueous solution of the solid multiuse composition as a floorcare agent, the floor surface has a coefficient of friction that is at least as high after the composition is applied as prior to application of the composition. The coefficient of friction of the floor surfaces treated with the dissolved aqueous solution described herein can be measured, for example, using the Universal Walkway Tester BOT 3000 to determine whether the composition had an effect on the coefficient of friction of a surface coated with the composition. Distinct coefficients of friction (CoF) can be measured: dry static coefficient of friction (Dry SCoF), static wet coefficient of friction (Wet SCoF) and wet dynamic coefficient of friction (Wet DCoF). Static CoF (SCoF) is the force required to initiate sliding of a static object on a surface divided by the force which maintains contact between the object and the surface. Dynamic CoF (DCoF) is the force required to arrest the motion of a moving object on a surface divided by the force which maintains contact between the object and the surface. A low CoF indicates high slipperiness. For most material combinations, the value of the static coefficient of friction exceeds that of the value of the dynamic coefficient of friction.

To measure dry SCoF, a leather sensor can be used with the BOT 3000, Binary Output Tribometer provided by Universal Walkway Testings. The sensor is sanded with a 320 grit pad and dusted. The sensor is then placed in the BOT 3000 and the dry static coefficient of friction is taken on the cleaner treated surface.

To measure the wet SCoF, a neolite sensor is used with the BOT 3000. The sensor is sanded with a 100 grit pad and dusted. The sensor is then equilibrated in about 0.5 inches of deionized water for about five minutes before being placed in the sensor port. A two by twenty inch trail of deionized water is applied on the surface of the cleaner treated sample. The BOT 3000 is then placed on the surface in the manner so that the sensor aligned with the trail of deionized water and the wet static coefficient of friction is taken.

To measure the wet DCoF, a neolite sensor is used with the BOT 3000. The sensor is sanded with a metal file about 0.5 inches thick and dusted. The sensor is then equilibrated in about 0.5 inches of deionized water for about five minutes before being placed in the sensor port. A two by twenty inch trail of deionized water is applied on the surface. The BOT 3000 is then placed on the surface in the manner so that the sensor aligned with the trail of the deionized water and the wet dynamic coefficient of friction was taken.

Additional embodiments include using the dissolved aqueous solution of the solid multiuse composition as a floorcare agent. Beneficially, in embodiments the use of the dissolved aqueous solution as a floorcare agent does not increase gloss of the floor measured at 600 by more than 3 points. In further embodiments, wherein applying the dissolved aqueous solution as a floorcare agent to the floor does not increase gloss of the floor measured at 600 by more than 5 points after 10 consecutive applications.

In other embodiments, using the dissolved aqueous solution of the solid multiuse composition as a floorcare agent does not result in any significant build-up of layers on the floor surface, such as for example layer that is less than 5 μm thick.

The dissolved aqueous solutions are in contact with a surface or article for a sufficient amount of time to clean the surface or article. In an aspect, the surface or article is contacted with the dissolved aqueous solutions for at least about 1 minute, at least about 10 minutes, or longer for a presoak application of use. In an aspect, the surface or article is contacted with the dissolved aqueous solutions for at least about 1 minute to at least about 3 hours for a presoak application of use. In a further aspect, the surface or article is contacted with the dissolved aqueous solutions for at least about 1 minute to a few hours for a manual detergent application of use. In other applications of use such as cleaning various hard surfaces the amount of time for contacting the surface will vary based on the nature of the soil and the surface as well as concentration of the dissolved aqueous solution employed.

The dissolved aqueous solutions can be dispensed and/or applied at a use or concentrate solution to a surface or article in need of cleaning. In an aspect, a use concentration of the dissolved aqueous solutions dispensed and/or applied has a concentration from about 1 ppm to about 10,000 ppm, from about 500 ppm to about 5,000 ppm, or preferably from about 500 ppm to about 1,000 ppm, or preferably between about 500 ppm to about 3,000 ppm, including all ranges therebetween. Beneficially the percarbonate and protease enzyme provides a synergy in efficacy for various challenging soils, including for a presoak, manual determent and/or other hard surface treatment, allowing use of a decreased concentration of chemistry.

It is a benefit of the multiuse and multipurpose compositions that a single dispenser can provide a use concentration of the dissolved aqueous solution. Dispensers can provide varying ranges as described herein based on the dispenser configuration. For example, in an embodiment commercially-available dispensers for multiuse compositions are dispensed between about 500 ppm to about 1,000 ppm for use concentration. In other embodiments, alternate commercially-available dispensers are designed to dispense a higher concentration, such as from about 2,000 ppm to about 3,000 ppm.

Beneficially, according to embodiments described herein the various applications of use of the multipurpose compositions do not require use of personal protective equipment by an end-user.

### EMBODIMENTS

The present disclosure is further defined by the following numbered embodiments:
1. A solid multiuse composition comprising: from about 1 wt-% to about 50 wt-% of alkalinity sources comprising an alkali metal percarbonate and/or an alkali metal carbonate; a protease enzyme; from about 20 wt-% to about 80 wt-% of at least one solid sulfonate surfactant; and at least additional functional ingredient.
2. The composition of paragraph 1, wherein the alkali metal percarbonate is sodium percarbonate and/or a modified anhydrous percarbonate salt.
3. The composition of any one of paragraphs 1-2, wherein the alkali metal percarbonate comprises from about 1 wt-% to about 30 wt-%, from about 5 wt-% to about 30 wt-%, from about 10 wt-% to about 30 wt-%, or from about 10 wt-% to about 20 wt-% of the composition and the alkali metal carbonate comprises from about 1 wt-% to about 20 wt-%, from about 1 wt-% to about 15 wt-%, from about 2 wt-% to about 15 wt-%, or from about 5 wt-% to about 15 wt-% of the composition.
4. The composition of any one of paragraphs 1-3, wherein the protease enzyme comprises from about 0.1 wt-% to about 5 wt-%, from about 0.1 wt-% to about 3 wt-%, or from about 0.1 wt-% to about 2 wt-% of the composition.
5. The composition of any one of paragraphs 1-4, wherein the solid sulfonate surfactant comprises sodium alpha olefin sulfonate.
6. The composition of any one of paragraphs 1-5, wherein the solid sulfonate surfactant comprises from about 30 wt-% to about 80 wt-%, from about 40 wt-% to about 70 wt-%, or from about 50 wt-% to about 70 wt-% of the composition.
7. The composition of any one of paragraphs 1-6, wherein the at least one additional functional ingredient is a nonionic surfactant comprising at least one of an alcohol ethoxylate, EO-PO block copolymer or amide, or an additional enzyme, preferably a cellulase enzyme.
8. The composition of paragraph 7, wherein the nonionic surfactant comprises from about 0.1 wt-% to about 10 wt-%, from about 0.5 wt-% to about 10 wt-%, from about 1 wt-% to about 10 wt-%, or from about 1 wt-% to about 6 wt-% of the composition, and wherein the additional enzyme comprises from about 0.01 wt-% to about 5 wt-% of the composition.
9. The composition of any one of paragraphs 1-9, herein the at least one additional functional ingredient is a filler comprising a water soluble magnesium and/or sodium salt and comprises from about 1 wt-% to about 40 wt-% of the composition.
10. The composition of any one of paragraphs 1-10, wherein the at least one additional functional ingredient is a polycarboxylic acid polymer, homopolymer, copolymer, and/or terpolymer and comprises from about 0.1 wt-% to about 15 wt-% on an actives basis of the composition.
11. The composition of paragraph 10, wherein the polymer is a polyacrylic acid polymer, copolymer, homopolymer or terpolymer.
12. A method of cleaning a surface or article comprising: contacting a surface or an article with a cleaning composition of any one of paragraphs 1-11 in a dissolved aqueous solution.
13. The method of paragraph 12, wherein the dissolved aqueous solution is a concentrate or use solution.
14. The method of paragraph 13, wherein the concentrate or use solution is between about 1 ppm to about 10,000 ppm, between about 500 ppm to about 5,000 ppm, or between about 500 ppm to about 1,000 ppm.
15. The method of any one of paragraphs 12-14, wherein the surface is a hard surface or wherein the article is a ware, preferably a pot and/or pan.
16. The method of any one of paragraphs 12-15, wherein the contacting of the article is a presoak application to remove baked on soils, and preferably wherein the baked on soils are at least about 90% removed, or about 100% removed.
17. The method of any one of paragraphs 12-16, wherein the contacting of the ware is a manual detergent application to remove various soils, and preferably wherein the soils are about 100% removed.
18. The method of any one of paragraphs 12-17, wherein the surface is a floor, and preferably wherein the floor surface has a coefficient of friction that is at least as high after the composition is applied as prior to application of the composition.
19. The method of any one of paragraphs 12-18, wherein the dissolved aqueous solution is used to clean more than one surface or article either at the same or a different dilution level.
20. The method of any one of paragraphs 12-19, further comprising rinsing the surface or article with water.
21. The method of any one of paragraphs 12-20, wherein the composition is free of magnesium sulfate and/or LAS to reduce build up in a dispenser for the dissolved aqueous solution.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

An enzymatic soil and scrub method was conducted to assess efficacy in soil removal of various detergents at varying concentrations. Stainless Steel surfaces were stained with burnt spaghetti and were washed using water, and six different detergents including Pot and Pan Control, Presoak Control 1, Presoak Control 2, Presoak Control 3, Multipurpose composition 11 and Multipurpose composition 12.

Enzymatic Soak and Scrub Test Methods included the following: Gardner Abrasion Tester; tile holder template for melamine tiles; 2-lb sponge holder; A5 Spectrophotometer/Colorimeter (HunterLab colorimeters used to measure the reflectance of the tiles); water bath with stirring; Balance; timer; screwdriver; 3M Scotch Brite sponges (pink) cut and prepared into 1.5×3 cm sponges; DM06 cheese baked on melamine tiles; and DM79 potato starch colored on melamine tiles. Each tile was 10×12 cm tile sheets cut in half into 6×10 cm tiles.

The reagents tested included the test formulas and inline/competitive product as outlined below.

The L Value for each tile was recorded before testing. The test results are compared directly using the change in the L value by calculating the % of soil removal through the formula: ΔL=L_{final}−Lᵢₙᵢₜᵢₐₗ. % of Soil Removal=ΔL/(L_{best}−Lᵢₙᵢₜₐₗ)*100%. L_{best}=L reading of a theoretically perfect clean tile; can be measured by soaking a test tile in large amount of respective enzyme for an extended period of time at 120 F or optimal temperature.

Pot and Pan Control is a commercially available alkaline detergent made up of NaOH and predominantly LAS/SLES (>40 wt-%) with additional polymers and surfactants.

Presoak Control 1 is a commercially available presoak composition with >50 wt-% sodium carbonate and further contains NaOH with additional polymers, chelants, surfactants, and a protease enzyme (Savinase 16T).

Presoak Control 2 is a commercially available presoak composition with >50 wt-% sodium carbonate and further contains sodium sesquicarbonate with additional polymers, surfactants, and a protease enzyme blend (Savinase/Stainzyme).

Presoak Control 3 is a commercially available presoak composition with >60 wt-% sodium carbonate and further contains NaOH with additional polymers and surfactants, and does not include any enzyme.

None of the control formulations include percarbonate with the alkalinity sources in combination with an enzyme as shown in Table 2, the Multipurpose Composition 12 utilized Progress Uno as an enzyme whereas the Multipurpose Composition 11 utilized Savinase and all other wt-% of the actives are the same between the two compositions.

Each stainless-steel sample was washed with 20 minutes of a static soak cycle and then rinsed with deionized water.

TABLE 2

| | Multipurpose | Multipurpose |
|---|---|---|
| Raw Material | Composition 11 | Composition 12 |
| Sodium Percarbonate | 8-12 | 8-12 |
| Sodium Carbonate | 8-12 | 8-12 |
| Sodium Sulfate | 10-15 | 10-15 |
| AOS granulate | 50-60 | 50-60 |
| Protease - Savinase | 0.1-1 | |
| Protease - Progress Uno | | 0.1-1 |
| Additional functional | 5-25 | 5-25 |
| ingredients (e.g. polymers, | | |
| magnesium salt, nonionic | | |
| surfactants, dye/fragrance) | | |
| Total | 100 | 100 |

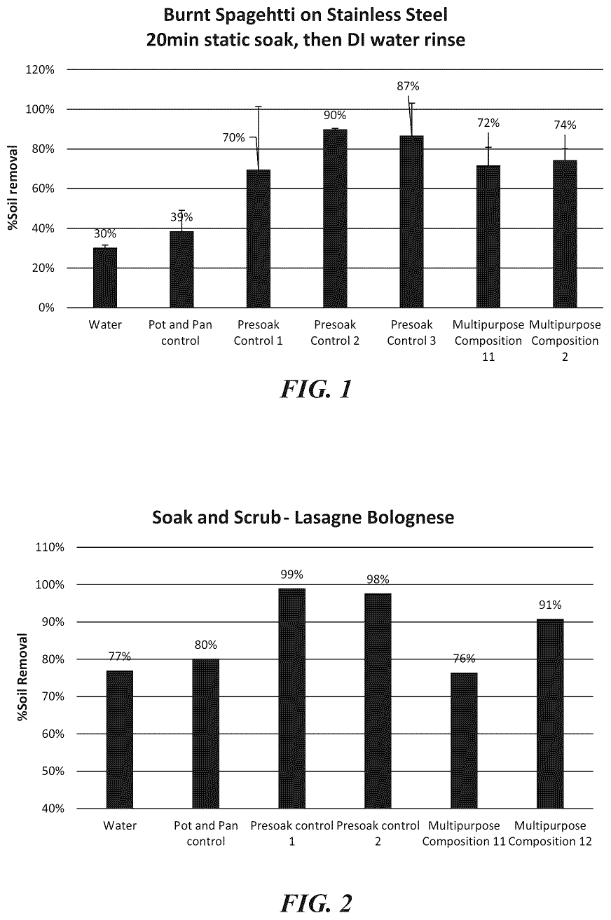

This example demonstrated a comparison of Pot and Pan Control to the other detergents to assess soil removal compared to inline detergents options. FIG. 1 shows the percentage of soil removal with each composition tested as well as the stainless-steel surface only treated with water (negative control). The samples of stainless steel with burnt spaghetti was treated with 800 ppm of Pot and Pan Control, 4000 ppm of Presoak Control 1, 4000 ppm Presoak Control 2, 3000 Presoak Control 3, and a decreased concentration of the Multipurpose Compositions 11 and 12—namely 1000 ppm of Multipurpose Composition 11 and 1000 ppm of Multipurpose Composition 12.

Although Presoak Control 1 and Presoak Control 2 were used at the highest concentration, FIG. 1 shows that Presoak Control 3 appeared to have the most efficacy for soil removal with a range of 87% to just over 100% soil removal. The other evaluated compositions, including the two Multipurpose compositions did not show the same range of soil removal. This indicated that the Multipurpose compositions which were created to perform as both presoak and soil removal detergents were not as effective as Presoak 3 with soil removal when comparing the lower ppm concentration.

However, the results demonstrate that these lower concentrations of each of the Multipurpose Compositions 11 and 12 required to achieve soil removal from a stainless steel surface are within scope of the other Presoak Controls. Multipurpose Composition 11 showed a 72% to just over 80% efficacy rate and Multipurpose Composition 12 showed markedly similar efficacy results. These results show that there is efficacious soil removal despite using less than half the concentration of the evaluated controls.

### Example 2

A series of 6×10 cm melamine tiles were stained with lasagna bolognese and were treated with water as well as the same six detergents outlines in Example 1. Each detergent was prepared as a test solution to soak each tile in before the tiles entered a Gardner Abrasion tester. Each testing solution was created by dissolving 0.7 grams of the detergent tested in 700 grams of 5 grain tap water using an 800 mL beaker. The solution was then heated to 120° F. or a desired temperature using a water bath with a stirrer. The concentrations of each detergent used were the same as those outlined in FIG. 1, namely 800 ppm of Pot and Pan Control, 4000 ppm of Presoak Control 1, 4000 ppm Presoak Control 2, and a decreased concentration of the Multipurpose Compositions 11 and 12—namely 1000 ppm of Multipurpose Composition 11 and 1000 ppm of Multipurpose Composition 12. It is noted that a lower concentration of Pot and Pan Control (800 ppm) was used in the example according to the recommended concentration use of the product. However, as the Pot and Pan Control does not contain enzyme, increasing the concentration to match the Multipurpose Compositions 11 and 12 or the significantly greater concentration of the Presoak Controls would not result in any significant difference as the formulation does not include an enzyme, and therefore the increase in concentration would not increase performance for an enzyme test method.

The test Melamine tiles were each placed into beakers with the prepared test solutions for each detergent and soaked statically for 20 minutes in 50° C. 5 grain water. The test tiles were removed after soaking and placed onto the tile holder template before being scrubbed in the Gardner Tester with a sponge and rinsed quickly with deionized water. The tiles were airdried prior to reading the results.

FIG. 2 shows the resulting abrasion data for each detergent following this procedure. The data suggests that the tiles treated with Presoak Control 1 and 20 scrubs in the Gardner Abrasion tester had the highest efficacy for soil removal with 99%. The Presoak Control 2 showed comparable results using only 18 scrubs.

The Multipurpose Composition 11 required 22 scrubs with a 76% soil removal, whereas the Multipurpose Composition 12 required only 20 scrubs and had a higher efficacy rate of 91% soil removal. The data suggests that the Multipurpose Composition 12 performs similarly to the Presoak 1 when undergoing the soak and scrub testing.

### Example 3

Two different detergents, Multipurpose Composition 11 and Pot and Pan Control, were tested with various drops of soil in order to assess the foam height. Foaming is needed to achieve an efficacious presoak and manual detergency and therefore is an important evaluation for the compositions. Foam height is defined as the total volume of liquid and foam.

The following ingredients were utilized in the Examples: A cylinder rotating device; graduated cylinders, (250 mL with rubber stoppers); disposable pipettes; hot plate; set of beakers and stir bars; balance; and timer.

Test Soils including Institutional Soil which were made of 45% Crisco Shortening, 30% Flour, 15% Powdered whole egg and 10% Oleic acid.

Test detergents were both liquid and solid. The liquid detergents were tested by scaling to a concentration or at 0.4 oz/gal with 5 grain water at room temperature. The solid detergents were tested at 0.2 oz/gal or scaled to another concentration.

To characterize each detergent's performance results were calculated through the formula: Total Foam Height=Sum of (Individual Foam Heights)−(Number of Foam Heights)−40 ml. 40 mL is the volume of test detergent added at the beginning of the test procedure. 40 mL of each test detergent were added to two different 250 mL graduated cylinders at room temperature. The soil added to each cylinder was liquified utilizing a hot plate at 200° F. and then drops of the soil were added to each cylinder. The cylinders were rotated at 30 rpm for four minutes in the cylinder rotating device. 2 drops of test soil were added using a pipette to the center of each cylinder, and each cylinder was rotated at 30 rpm for 2 minutes again before adding another 2 more drops of test soil in each cylinder. This cycle was repeated until each cylinder attained a foam height of 45 mL or less.

The scale on each 250 mL graduated cylinder was then used to measure the foam height in millimeters of foam and rounded to the nearest 5 mL. The detergent's performance was then calculated utilizing the formula mentioned section above regarding total foam height.

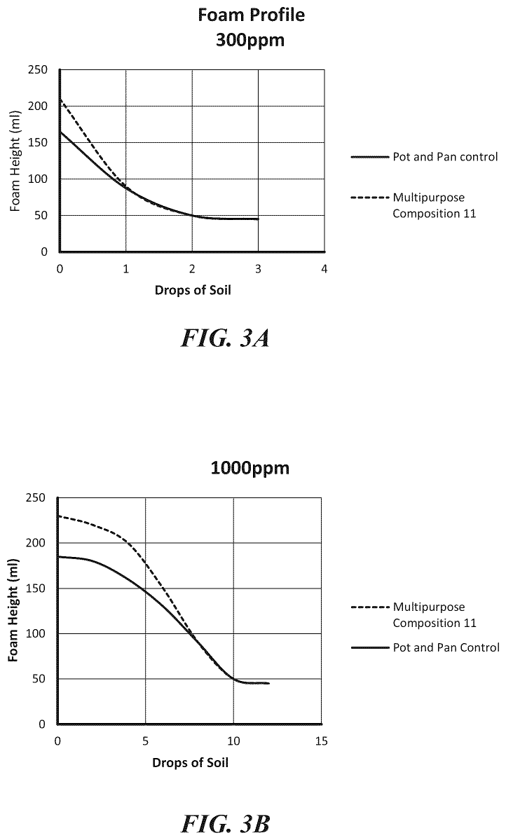

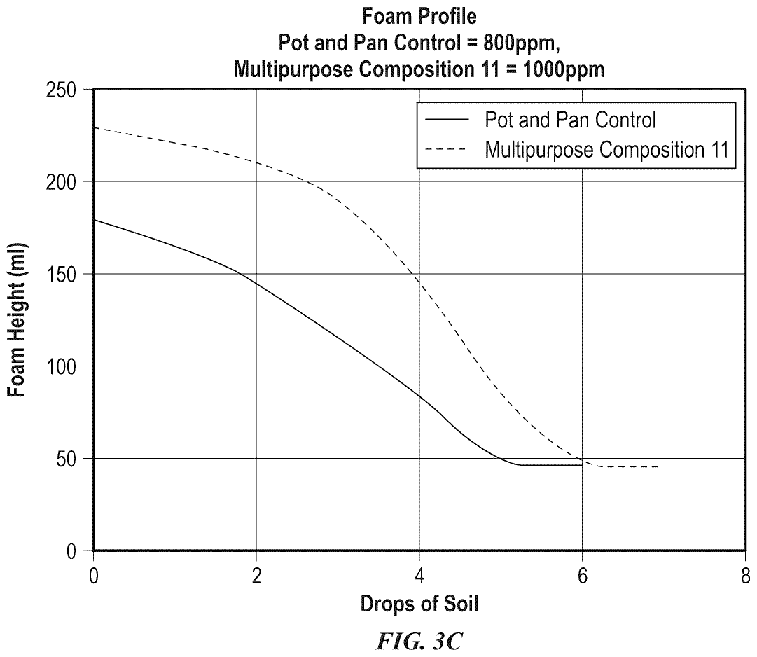

FIG. 3A demonstrates the comparison of Pot and Pan Control detergent and Multipurpose Composition detergents when both are at an equivalent concentration of 300 ppm. The results suggest that with no drops of soil, the Multipurpose Composition 11 achieves a higher foam height compared to Pot and Pan control. This trend continues until both detergents were tested with 1 drop of soil or more. The results indicated that the Multipurpose Composition performed similarly and have the same foam height.

FIG. 3B demonstrates the same comparison of Pot and Pan Control detergent and Multipurpose Composition 11 where both are an equivalent concentration of 1000 ppm in order to assess different foam heights. The results suggest that with no drops of soil, the Multipurpose Composition appears to have a higher foam height compared to Pot and Pan control. This trend continued until the detergents both were tested with just over 7 drops of soil or more. At this point, the results once again indicated that both detergents performed similarly and have the same foam height.

FIG. 3C further demonstrates another comparison of Pot and Pan Control detergent and Multipurpose Composition 11 where the teste range of the Pot and Pan Control detergent is at 800 ppm and the Multipurpose Composition 11 is at 1000 ppm to further assess different foam heights, when using the recommended maximum dose of 300-800 ppm of the Pot and Pan Control detergent. The results again show that with no drops of soil, the Multipurpose Composition 11 appears to have a higher foam height compared to Pot and Pan control. This trend continued until the detergents both were tested with 6 drops of soil even with the increased concentration of the Multipurpose Composition, and thereafter the results once again indicated that both detergents performed similarly and have the same foam height.

### Example 4

The Multipurpose Composition 11, Presoak Controls 1, 2 and 4, Pot and Pan Control 2, and Pot and Pan Control, Floorcare A, and Floorcare B were tested against Modified Red Soil on vinyl composite tile (VCT) to see how effective each solution is on cleaning the soil from a floor surface using a colorimeter reading along with measuring weight loss of surfaces. This example included additional formulations, including the following:

Pot and Pan Control 2 is a commercially available product with a predominant amount of LAS, various inorganic salts, surfactants and polymers and other defoaming agents.

Floorcare A which is a commercially available acidic floor care composition with an acid and predominant amount of sodium alkyl benzene sulfonate along with additional polymers/surfactants, and excluding an enzyme.

Floorcare B which is a commercially available basic floor care composition with alkaline sources and predominant amount of sodium alkyl benzene sulfonate along with additional polymers/surfactants, and excluding an enzyme.

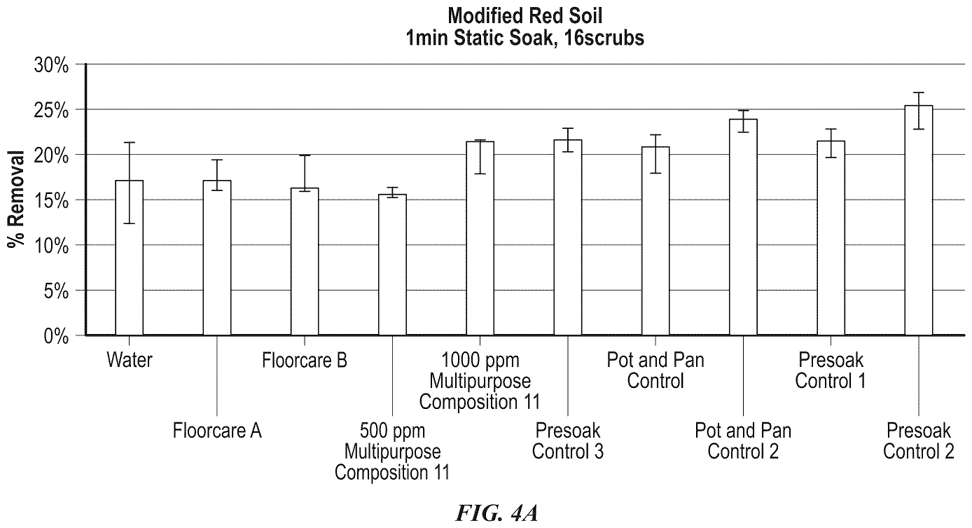

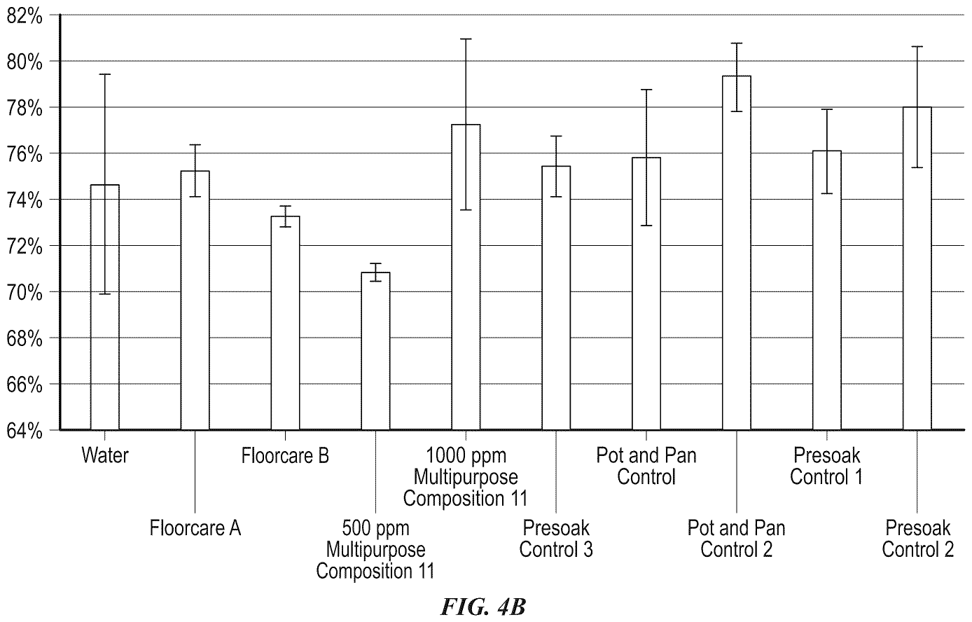

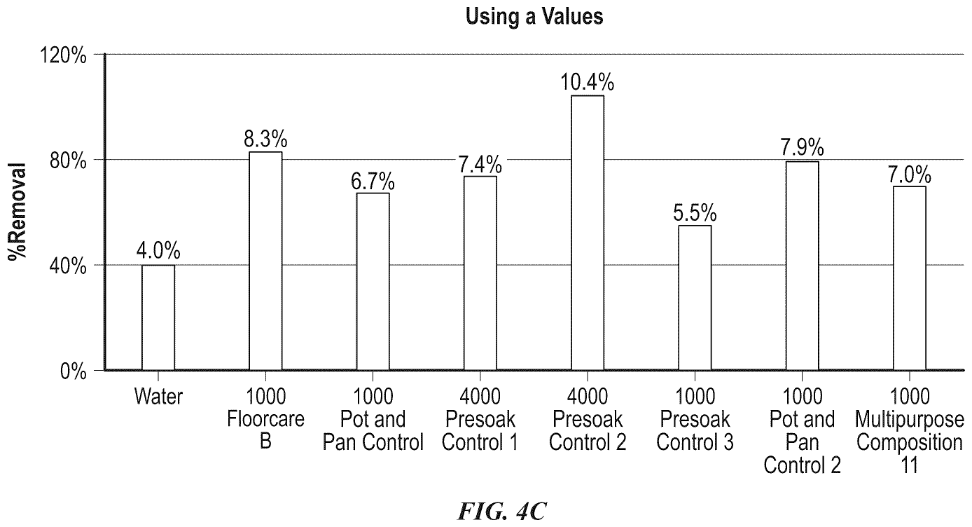

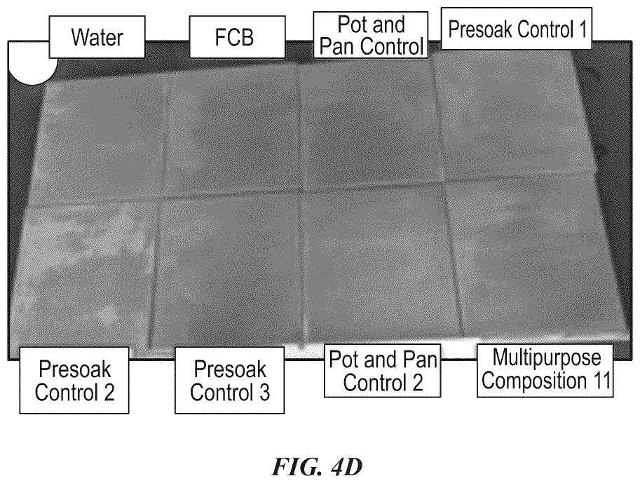

For this test Multipurpose Composition 11 was evaluated at 2 concentrations. There were two methods used to review the modified red soil data 1) using colorimeter and 2) looking at the coupons change in weight before and after cleaning, as shown in FIGS. 4A and 4B, respectively.

The modified red soil composition is made with 38.9% shortening, 19.4% corn oil, 29.1% whole egg powder, 9.7% potato starch, and 2.9% iron oxide.

FIG. 4A shows the effectiveness of each solution outlined above against Modified Red Soil as measured by % removal based on L values from colorimeter measurements.

FIG. 4B shows similar data with the same solutions outlined above with the weight removed instead of a colorimetric reading.

The results of FIG. 4A indicate that the Presoak Control 2 appeared to be the most effective against Modified Red Soil off a floor surface.

The results of FIG. 4B indicate that ASPC appears to be the most effective solution against Modified Red Soil off a floor surface. The results in FIG. 4B evaluating the % change in mass, indicative of removal of soils, provided a better indicator than colorimeter readings.

The results of FIG. 4C show the removal of the modified red soil composition on quarry red floor tiles, with colorimeter readings to assess % soil removal showing that the Multipurpose Composition performs within a desired range of soil removal. Due to the color of the tile, the results are more focused on qualitative performance (FIG. 4D) instead of the quantitative measurement of % removal of soil, as very low measurements are obtained due to the use of colorimetric measurements. Therefore, the visual inspection as shown in the photographs in FIG. 4D is a visual indicator of desired performance of the Multipurpose Composition consistent with the data of % soil removal in FIG. 4C.

### Example 5

The Multipurpose Composition Formula was modified to include an expanded sodium percarbonate as shown in Table 3 to evaluate an additional formulation that enables loading of liquid components into the solid composition.

TABLE 3

| Raw Material | Multipurpose Composition 13 (wt-%) |
|---|---|
| Sodium Percarbonate | 8-12 |
| Sodium Carbonate | 10 |
| Sodium Sulfate | 10-15 |
| AOS granulate | 50-60 |
| Protease - Savinase | 0.1-1 |
| Additional functional | 5-25 |
| ingredients (polymers, | |
| magnesium salt, nonionic | |
| surfactants) | |
| Total | 100 |

Table 4 demonstrates the formula used for the Multipurpose Composition Detergent 14 and 15 Formulas including the expanded sodium percarbonate. The Multipurpose Composition formula was changed from 1000 light ash to 500 expanded sodium percarbonate and increasing the polymer used in the formula (Acusol 445 ND).

TABLE 4

| | Multipurpose | Multipurpose |
|---|---|---|
| Raw Material | Composition 14 | Composition 15 |
| Sodium Carbonate | 0 | 1-5 |
| Sodium Percarbonate | 8-12 | 8-10 |
| Expanded Sodium | 5 | 5 |
| Percarbonate | | |
| Sodium Sulfate | 10-15 | 3-8 |
| AOS granulate | 50-60 | 55-65 |
| Protease - Savinase/ | 0.1-1 | 0.1-1 |
| Esperase 6T | | |
| Additional functional | 5-25 | 5-25 |
| ingredients (polymers, | | |
| magnesium salt, nonionic | | |
| surfactants) | | |
| Total | 100 | 100 |

Blocks between about 0.85-1.2 kg were pressed of the various compositions. Table 5 shows the dimensional stability data of each version of the pressed Multipurpose composition 14 evaluated over time and at room temperature (RT), and temperatures of 40° C. and 65% relative humidity. The term “dimensional stability” and “dimensionally stable” as used herein, refer to a solid composition having a growth exponent of less than about 5%. If the solid product swells more than 5% after solidification, various problems may occur, including but not limited to decreased density, integrity, and appearance; and inability to dispense or package the solid product. Generally, a solid product is considered to have dimensional stability if the solid product has a growth exponent of less than about 5%, or preferably less than about 4%.

Growth exponent refers to the percent growth or swelling of the evaluated product over a period of time after solidification under normal transport/storage conditions. Because normal transport/storage conditions for products often results in the composition being subjected to an elevated temperature, the growth exponent of a solid product may be determined by measuring one or more dimensions of the product prior to and after heating at between about 100° F. (38° C.) and 122° F. (50° C.). The measured dimension or dimensions depends on the shape of the solid product and the manner in which it swells. For blocks, the change in both width and height is generally measured and added together to determine the growth exponent.

TABLE 5

| Number of Weeks/ | | | |
|---|---|---|---|
| Composition tested | RT | 40° C./65% | 50° C. |
| 0 Weeks measurement 1 | 4.092 | 4.094 | 4.072 |
| 0 Weeks measurement 2 | 4.069 | 4.084 | 4.078 |
| 0 Weeks height | 4.008 | 4.01 | 4.044 |
| 2 Weeks measurement 1 | 4.103 | 4.1 | 4.076 |
| 2 Weeks measurement 2 | 4.091 | 4.09 | 4.083 |
| 2 weeks height | 4.011 | 4.035 | 4.038 |
| 4 Weeks measurement 1 | 4.104 | 4.094 | 4.078 |
| 4 Weeks measurement 2 | 4.095 | 4.085 | 4.077 |
| 4 weeks height | 4.005 | 4.025 | 4.049 |
| 8 Week measurement 1 | 4.092 | 4.101 | 4.064 |
| 8 Week measurement 2 | 4.085 | 4.085 | 4.066 |
| 8 Week height | 4.008 | 4.023 | 4.018 |

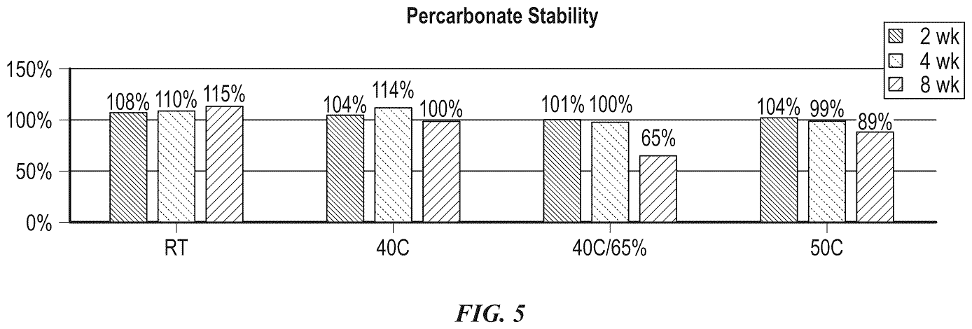

In addition to the dimensional stability results in Table 5, FIG. 5 shows results assessing the percarbonate stability using titration data evaluating the expanded percarbonate stability in a large block (between about 0.85-1.2 kg). FIG. 5 percarbonate stability measures percent oxygen in the large blocks to show how stable the sodium percarbonate is over time—at 2 weeks, 4 weeks, and 8 weeks. A Hach peroxide test kit (HYP-1) was used to assess the stability. As little to no loss of activity as possible is desired. A loss of activity at 40 C/65%, which is an extreme condition to simulate a dispenser, was observed.

### Example 6

Dispensing analysis of the solid multipurpose compositions was also conducting comparing composition 15 with and without magnesium sulfate and/or LAS for impact of the magnesium sulfate and LAS on clogging or build-up of particulates in dispensing equipment was completed. Although various dispensing equipment can be employed to dissolve a solid composition, certain commercially-available dispensers can clog when particulate builds up. The removal of one or both of magnesium sulfate and LAS (and the formula backfilled with sodium sulfate as otherwise shown in Table 4) prevented clogging of one type of commercial dispensing equipment, indicating a benefit in formulation depending on dispenser selection.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A solid multiuse composition comprising:
from about 1 wt-% to about 50 wt-% of alkalinity sources comprising an alkali metal percarbonate and/or an alkali metal carbonate;
a protease enzyme;
from about 20 wt-% to about 80 wt-% of at least one solid sulfonate surfactant; and
at least additional functional ingredient.

2. The composition of claim 1, wherein the alkali metal percarbonate is sodium percarbonate and/or a modified anhydrous percarbonate salt.

3. The composition of claim 1, wherein the alkali metal percarbonate comprises from about 1 wt-% to about 30 wt-% of the composition and the alkali metal carbonate comprises from about 1 wt-% to about 20 wt-% of the composition.

4. The composition of claim 1, wherein the protease enzyme comprises from about 0.1 wt-% to about 5 wt-% of the composition.

5. The composition of claim 1, wherein the solid sulfonate surfactant comprises sodium alpha olefin sulfonate.

6. The composition of claim 1, wherein the solid sulfonate surfactant comprises from about 30 wt-% to about 80 wt-% of the composition.

7. The composition of claim 1, wherein the at least one additional functional ingredient is a nonionic surfactant comprising at least one of an alcohol ethoxylate, EO-PO block copolymer or amide, or an additional enzyme comprising a cellulase, lipase and/or amylase enzyme.

8. The composition of claim 7, wherein the nonionic surfactant comprises from about 0.1 wt-% to about 10 wt-% of the composition, and wherein the additional enzyme comprises from about 0.01 wt-% to about 5 wt-% of the composition.

9. The composition of claim 1, herein the at least one additional functional ingredient is a filler comprising a water soluble magnesium and/or sodium salt and comprises from about 1 wt-% to about 40 wt-% of the composition.

10. The composition of claim 1, wherein the at least one additional functional ingredient is a polycarboxylic acid polymer, homopolymer, copolymer, and/or terpolymer and comprises from about 0.1 wt-% to about 15 wt-% on an actives basis of the composition.

11. The composition of claim 10, wherein the polymer is a polyacrylic acid polymer, copolymer, homopolymer or terpolymer.

12. A method of cleaning a surface or article comprising:
contacting a surface or an article with a cleaning composition of claim 1 in a dissolved aqueous solution.

13. The method of claim 12, wherein the dissolved aqueous solution is a concentrate or use solution.

14. The method of claim 13, wherein the concentrate or use solution is between about 1 ppm to about 10,000 ppm, between about 500 ppm to about 5,000 ppm, or between about 500 ppm to about 1,000 ppm.

15. The method of claim 12, wherein the surface is a hard surface or wherein the article is a ware, preferably a pot and/or pan.

16. The method of claim 12, wherein the contacting of the article is a presoak application to remove baked on soils, and preferably wherein the baked on soils are at least about 90% removed, or about 100% removed.

17. The method of claim 12, wherein the contacting of the ware is a manual detergent application to remove various soils, and preferably wherein the soils are about 100% removed.

18. The method of claim 12, wherein the surface is a floor, and preferably wherein the floor surface has a coefficient of friction that is at least as high after the composition is applied as prior to application of the composition.

19. The method of claim 12, wherein the dissolved aqueous solution is used to clean more than one surface or article either at the same or a different dilution level.

20. The method of claim 12, further comprising rinsing the surface or article with water and/or wherein the composition is free of magnesium sulfate and/or LAS to reduce build up in a dispenser for the dissolved aqueous solution.
